(19) United States
(12) Patent Application Publication
(10) Pub. No.: US 2003/0179984 A1
(43) Pub. Date: Sep. 25, 2003

(54) Method and device for direct ultrahigh speed conversion from time signal to space signal

(76) Inventors: Tsuyoshi Konishi, Osaka (JP); Yoshiki Ichioka, Hyogo (JP)

Correspondence Address: MCGLEW & TUTTLE, PC, SCARBOROUGH STATION, SCARBOROUGH, NY, 10510, US

(21) Appl. No.: 10/311,791

(22) PCT Filed: Jun. 19, 2001
(86) PCT No.: PCT/JP01/05206

(30) Foreign Application Priority Data
Jun. 19, 2000 (JP) 2000-182667

(51) Int. Cl. G02B 6/26; G02B 6/42

(52) U.S. Cl. 385/16

(57) ABSTRACT

In a method for directly converting at an ultra-high speed, a signal light pulse (3, 3′) and a reference ultra-short light pulse (4) each having an appropriate spatially lateral width are launched simultaneously into an ultra-high-speed optical memory element (2) from both sides of an optical axis thereof at appropriate angles with respect to the axis, temporal waveforms of the signal light pulse (3, 3′) and reference ultra-short light pulse (4) are projected onto a plane, an interference fringe (5, 5′) produced by interference between spatial projection images of two moving light waves corresponding to cross-correlation waveforms of the signal light pulse (3, 3′) and reference ultra-short light pulse (4) is retained in the ultra-high-speed optical memory element (2), and a spatial distribution of self-diffracted light (7, 7′) of the reference ultra-short light pulse produced in accordance with the spatial distribution of the retained interference fringe corresponding to the cross-correlation waveforms is imaged using an image forming lens (8) and thus, is converted into a spatial distribution corresponding to the temporal waveform of the input signal light pulse (3, 3′).

### TECHNICAL FIELD

This invention relates to a method and apparatus for directly converting a time signal into a spatial signal at an ultra-high speed, more particularly to a method and apparatus for directly converting an ultra-short optical pulse time signal into a spatial signal at an ultra-high speed without any Fourier transform process or the like.

### BACKGROUND ART

In the field of optical communication, with the aim of real-time transmission of multimedia information including image data, sound data and text data, transmission capacity has been increased in recent years by time division multiplexing, wavelength division multiplexing or the like. However, since the signals used are in the form of time signals, as the transmission capacity becomes higher, it becomes needed to perform, at an ultra-high speed, conversion (encoding) of spatial information to be transmitted, such as an image, into time signals and development (decoding) of information in the form of time signals into spatial information.

An indirect method for converting between a time signal and a spatial information signal at an ultra-high speed based on the spectroscopic technology was proposed in a Reference 1 (Opt. Spectrosc., Vol. 57, pp. 1-6) in 1984. The method is advantageous in that conversion can be achieved without any dynamic device, but is disadvantageous in that any signal after conversion is only in the form of Fourier-transformed signal. Therefore, in any processing after conversion, the processing needs to be performed via the Fourier transform, and the time signal cannot be directly processed.

Besides, a method for developing a time signal into a spatial signal using interference was proposed in a Reference 2 (Opt. Lett., Vol. 18, pp. 2129-2131) in 1993. The method is advantageous in that the time signals can directly developed into the spatial form of interference fringes, but is disadvantageous in that the resulting signals can only be in the form of interference fringes and thus are difficult to process after the development.

In the past, various types of methods for converting between a time signal and a spatial information signal at an ultra-high speed have been proposed. According to these conventional methods, however, direct conversion between the time signals themselves and the spatial signals is impossible, while conversion between a frequency distribution of the time signals and the spatial signals is possible.

An object of the present invention is to provide a method for directly converting a time signal into a complete spatial signal at an ultra-high speed without any Fourier transform process.

Another object of the present invention is to provide an apparatus for directly converting a time signal into a complete spatial signal at an ultra-high speed without any Fourier transform process.

### DISCLOSURE OF THE INVENTION

In order to attain the above-described objects, according to the present invention, a signal light pulse and a reference ultra-short light pulse each having an appropriate spatially lateral width are launched simultaneously into a surface of an ultra-high-speed optical memory element from both sides of an optical axis thereof at appropriate angles with respect to the axis to project waveforms of time signals of the signal light pulse and reference ultra-short light pulse onto the surface of the ultra-high-speed optical memory element, an interference fringe produced by interference between spatial projection images of two moving light waves corresponding to cross-correlation waveforms of the signal light pulse and reference ultra-short light pulse is retained in the ultra-high-speed optical memory element, and a spatial distribution of self-diffracted light of the reference ultra-short light pulse produced in accordance with the spatial distribution of the retained interference fringe corresponding to the cross-correlation waveforms is determined and regarded as a spatial signal corresponding to the original time signal, whereby a time signal is directly converted into a spatial signal at an ultra-high speed.

### BRIEF DESCRIPTION OF THE DRAWINGS

FIG. 1 shows an arrangement of a time-to-spatial signal conversion optical system according to one embodiment of the invention.

FIG. 2 illustrates a process of generation of interference fringes due to interference between a signal light pulse and a reference ultra-short light pulse.

### BEST MODE FOR CARRYING OUT THE INVENTION

Now, a preferred embodiment of the invention will be described with reference to the accompanying drawings.

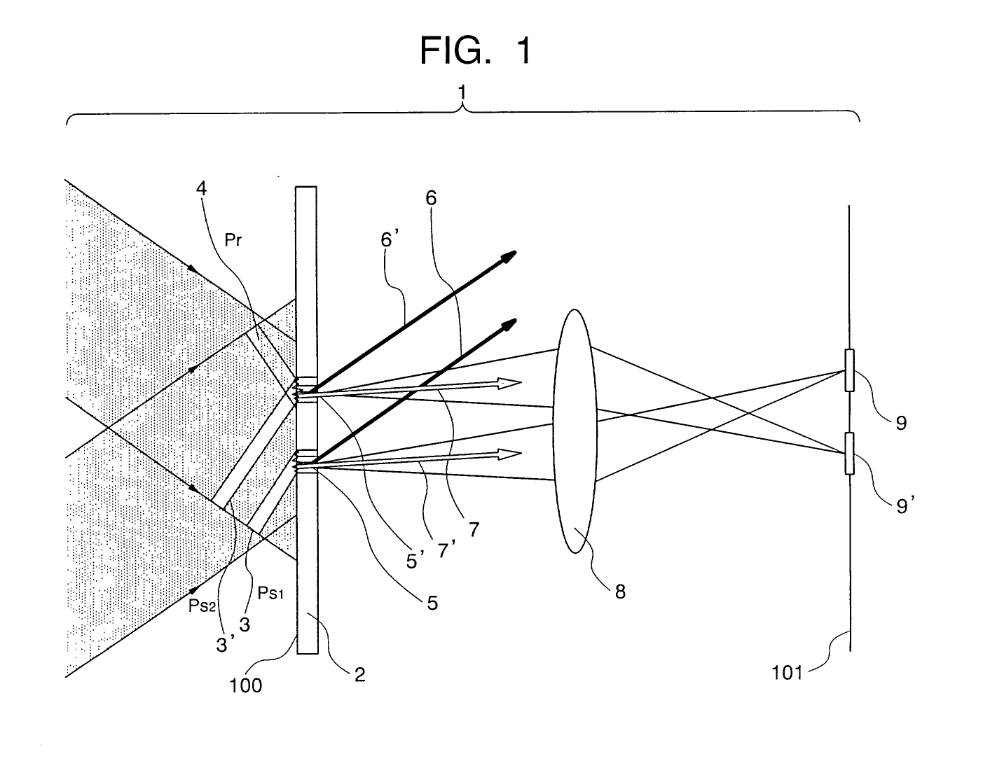

FIG. 1 shows an arrangement of a time-to-spatial signal conversion optical system that implements a method for directly converting a time signal into a spatial signal at an ultra-high speed according to the invention.

In FIG. 1, reference numeral 1 denotes a time-to-spatial signal conversion optical system, reference numeral 2 denotes an ultra-high-speed optical memory element, reference numerals 3 and 3′ denote signal light pulses (indicated by P_{S1}, and P_{S2}, respectively), reference numeral 4 denotes a reference ultra-short light pulse (indicated by Pᵣ), reference numerals 5 and 5′ denote interference fringes, reference numerals 6 and 6′ denote transmitted light of the reference ultra-short light pulses, reference numerals 7 and 7′ denote primary diffracted light of the reference ultra-short light pulses due to self-diffraction, reference numeral 8 denotes an image forming lens, reference numerals 9 and 9′ denote an output spatial distribution, reference numeral 100 denotes an incidence plane, and reference numeral 101 denotes an output plane.

The time-to-spatial signal conversion optical system 1 converts the received signal light pulses 3, 3′ in the form of time signals into spatial signals and outputs them on the output plane 101 in the form of the output spatial distribution 9, 9′.

For simplification, only two signal light pulses 3, 3′ to be converted are shown in this embodiment. However, any plurality of signal light pulses may be launched in burst as far as the signal light pulses can individually interfere with the reference ultra-short light pulse to form their respective interference fringes on the ultra-high-speed optical memory element 2. Such signal light pulses in burst include signals resulting from ultra-high-speed scanning of a binary image and signals resulting from multiplexing of multi-channel data.

The ultra-high-speed optical memory element 2 can modify optical characteristics thereof, such as transmittance (absorptance) and refractive index, in accordance with the intensity of light incident thereon and retain the modified state. It may be a semiconductor device or a spatially modified liquid crystal optical element that has a multiple quantum well (MQW) structure.

The signal light pulses 3, 3′ having an appropriate spatially lateral width and the reference ultra-short light pulse 4 also having an appropriate spatially lateral width are launched into the ultra-high-speed optical memory element 2 from both sides of an optical axis at appropriate angles with respect to the axis. Then, the incidence plane 100 is scanned at the speed of light with wave fronts of the signal light pulses 3, 3′ (P_{S1}, P_{S2}) and the wave front of the reference ultra-short light pulse 4 (Pᵣ), which have reached the incidence plane 100 of the ultra-high-speed optical memory element 2, in opposite directions.

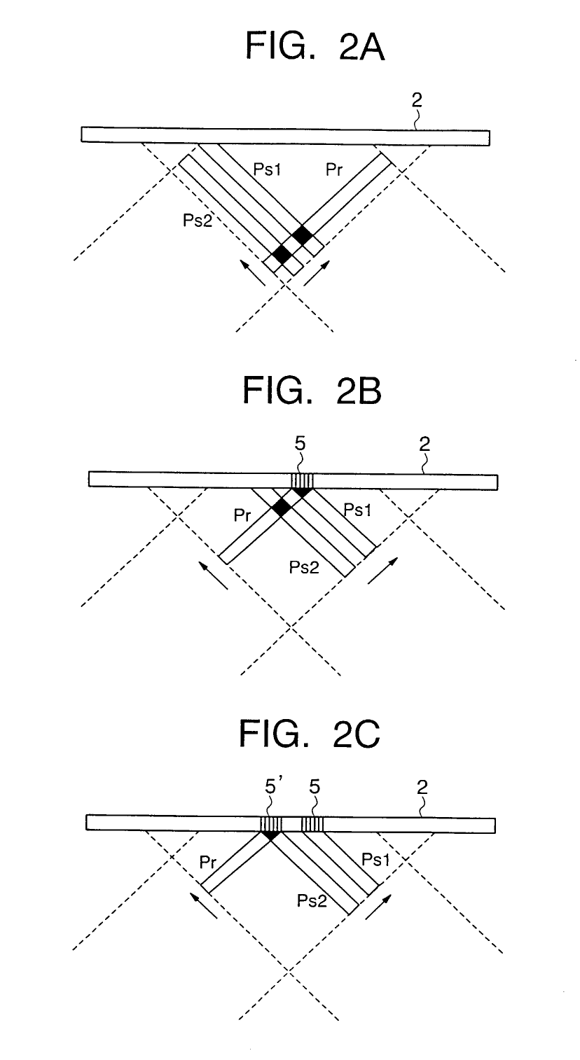

A pair of the light pulses P_{S1} and Pᵣ scanning the incidence plane 100 in the opposite directions interfere with each other at a spatial position where the wave fronts thereof simultaneously reach, thereby producing the interference fringe 5. Then, a pair of the light pulses P_{S2} and Pᵣ scanning the incidence plane 100 in the opposite directions interfere with each other at a spatial position where the wave fronts thereof simultaneously reach, thereby producing the interference fringe 5′. A spatial distribution of the resulting interference fringes 5, 5′ corresponds to cross-correlation waveforms of spatial projection images of the interference light pulses. FIG. 2 shows a process of generation of the interference fringes 5, 5′.

FIG. 2A shows a state in which one end of the signal light pulse P_{S1} has reached the surface of the ultra-high-speed optical memory element 2, and the signal light pulse P_{S2} and the reference ultra-short light pulse Pᵣ have not yet reached it. At this point in time, both positions of interference between the pulses P_{S1} and Pᵣ and between the pulses P_{S2} and Pᵣ are distant from the surface of the ultra-high-speed optical memory element 2.

FIG. 2B shows a state in which one end of the reference ultra-short light pulse Pᵣ reaches the surface of the ultra-high-speed optical memory element 2 and interferes with the signal light pulse P_{S1} to produce the interference fringe 5, and the interference fringe 5 is retained in the ultra-high-speed optical memory element 2. At this point in time, although the pulse P_{S2} has already reached the surface of the ultra-high-speed optical memory element 2, the position of interference between the pulses P_{S2} and Pᵣ is still distant from the surface of the ultra-high-speed optical memory element 2.

FIG. 2C shows a state in which the signal light pulse P_{S2} and the reference ultra-short light pulse Pᵣ cross each other in the surface of the ultra-high-speed optical memory element 2 and interfere with each other to produce the interference fringe 5′, and the interference fringe 5′ is retained in the ultra-high-speed optical memory element 2.

When the interference fringe 5 or 5′ is produced in the surface of the ultra-high-speed optical memory element 2, in the region where the interference fringe is produced, modification in optical characteristics including transmittance (absorptance) in accordance with the interference fringe pattern is attained and retained in an extremely short time. Therefore, at the point in time when the reference ultra-short light pulse Pᵣ produces the interference fringe 5 or 5′, it is self-diffracted by the interference fringe to provide the transmitted light 6, 6′ and the primary diffracted light (self-diffracted light) 7, 7′.

Here, focusing only the primary diffracted light 7, 7′ on the output plane 101 by the image forming lens 8 can provide, on the output plane 101, the output spatial distribution 9, 9′ corresponding to time signal waveforms of the input signal light pulses 3, 3′.

The conversion performance of the time-to-spatial signal conversion optical system 1 according to the invention depends on the spatially lateral widths of the input light pulses and reference light pulse, the pulse durations of the input light pulses and reference light pulse, the interval between the input light pulses in the burst, and the maximum number of the input light pulses in the burst. In particular, in response to a phase difference between the input light pulse and the reference light pulse, the position of the interference fringe produced in the surface of the ultra-high-speed optical memory element 2 is changed and the output spatial distribution 9, 9′ in the output plane 101 is also changed in position. Thus, the condition of generating the reference light pulse is adapted to be changed via various design values, so that the condition of producing the interference fringes in the surface of the ultra-high-speed optical memory element 2 can be appropriately controlled.

Although not shown, an array of photocells or an image pick-up device, such as a CCD, may be disposed in the output plane 101 with being associated with the output spatial distribution 9, 9′, thereby electrically extracting the output spatial signals distributed in the output plane. Alternatively, light-receiving ends of multiplexed optical waveguides or optical fibers may be disposed in the output plane 101 with being associated with the output spatial distribution 9, 9′, thereby optically extracting the spatial signals.

As described above, input signal light pulses of time signals can be converted into spatial signals. For example, if the input signal light pulses are time signals resulting from scanning of an image, the original image can be spatially developed on the output plane. Besides, if the input signal light pulses are time signals resulting from multiplexing of multi-channel data, the data for the individual channels can be output separately on the output plane.

The invention should not be limited to the embodiment described above, and many modifications and alterations thereto are possible. For example, only one lens is used for image formation in the above-described embodiment. However, if the output plane needs to be further distant from the ultra-high-speed optical memory element 2, a telecentric optical system including two lenses may be used.

### INDUSTRIAL APPLICABILITY

As described above, with the method and apparatus for directly converting a time signal into a spatial signal at an ultra-high speed according to the invention, the time signal can be directly converted into the spatial signal at an ultra-high speed, rather than indirectly through a spectroscopic technology which is essential in conventional manners.

1. A method for directly converting a time signal into a spatial signal at an ultra-high speed, the method comprising:
using a signal light pulse and a reference ultra-short light pulse, each having a predetermined spatially lateral width;
launching the signal light pulse and the reference ultra-short light pulse simultaneously into a surface of an ultra-high-speed optical memory element from both sides of an optical axis thereof at appropriate angles with respect to the axis;
retaining an interference fringe produced by interference between moving spatial projection images of waveforms of time signals of the incident signal light pulse and reference ultra-short light pulse in the ultra-high-speed optical memory element; and
converting a spatial distribution of self-diffracted light of the reference ultra-short light pulse produced in accordance with the retained interference fringe into a spatial signal output corresponding to the time signal of the original signal light pulse.

2. A method for directly converting a time signal into a spatial signal at an ultra-high speed according to claim 1, wherein the spatially lateral widths of the signal light pulse and reference ultra-short light pulse are large enough for the moving spatial projection images of the waveforms of the time signals of the signal light pulse and reference ultra-short light pulse incident on the surface of the ultra-high-speed optical memory element to interfere with each other in the surface of the ultra-high-speed optical memory element to produce the interference fringe.

3. A method for directly converting a time signal into a spatial signal at an ultra-high speed according to claim 1, wherein a condition of generating the reference ultra-short light pulse is adapted to be changeable to control a condition of producing the interference fringe.

4. An apparatus for directly converting a time signal into a spatial signal at an ultra-high speed, the apparatus comprising:
an ultra-high-speed optical memory element that is capable of modifying a transmission characteristic or a refractive index thereof in accordance with light incident thereon and retaining the modified state;
signal light pulse launching means for launching a signal light pulse into a surface of the ultra-high-speed optical memory element at a predetermined angle with respect to an optical axis of the element; and
reference ultra-short light pulse launching means for launching, simultaneously with the signal light pulse, a reference ultra-short light pulse into the surface of the ultra-high-speed optical memory element from a side of the optical axis opposite to the signal light pulse at a predetermined angle with respect to the optical axis, and
wherein an interference fringe produced by interference, in the surface of the ultra-high-speed optical memory element, between waveforms of time signals of the signal light pulse launched by the signal light pulse launching means and reference ultra-short light pulse launched by the reference ultra-short light pulse launching means is retained in the ultra-high-speed optical memory element, and a spatial distribution of self-diffracted light of the reference ultra-short light pulse produced in accordance with the retained interference fringe is converted into a spatial signal output corresponding to the time signal of the original signal light pulse.

5. An apparatus for directly converting a time signal into a spatial signal at an ultra-high speed according to claim 4, wherein the ultra-high-speed optical memory element is a semiconductor device having a multiple quantum well structure.

6. An apparatus for directly converting a time signal into a spatial signal at an ultra-high speed according to claim 4, wherein a plurality of optical detector elements or a plurality of optical waveguides are disposed in accordance with the produced spatial distribution of the self-diffracted light of the reference ultra-short light pulse.
